(19) United States
(12) Patent Application Publication
(10) Pub. No.: US 2004/0054791 A1
(43) Pub. Date: Mar. 18, 2004

(54) System and method for enforcing user policies on a web server

(76) Inventors: Krishnendu Chakraborty, San Mateo, CA (US); Pirasenna Thiyagaranjan, Santa Clara, CA (US); Xuesi Dong, Sunnyvale, CA (US)

Correspondence Address: WAGNER, MURABITO & HAO LLP, Third Floor, Two North Market Street, San Jose, CA, 95113, US

(21) Appl. No.: 10/246,072

(22) Filed: Sep. 17, 2002

(51) Int. Cl. G06F 15/16

(52) U.S. Cl. 709/229; 709/219

(57) ABSTRACT

A system and method for enforcing user policies on web servers. Embodiments of the present invention include a policy agent that enforces user policies on web servers that is generic to any web server platform. In one embodiment, a generic policy engine comprises a core policy level that caches the policy definitions by fetching user policies from an identity server and returns the policy values and an interface layer that interfaces the policy library with the web server and enforces the policies for specific users and applications. In one embodiment of the present invention, one core policy library can be shared by a plurality of policy agents running on different web servers.

### BACKGROUND OF THE INVENTION

1. Field of the Invention

The field of the invention relates to data processing. More specifically, embodiments of the present invention relate to the enforcement of user policies on web servers.

2. Related Art

Computer systems typically include a combination of hardware (e.g., semiconductors, circuit boards, etc.) and software (e.g., computer programs). As advances in semiconductor processing and computer architecture push the performance of computer hardware higher, more sophisticated computer software has evolved to take advantage of the higher performance of the hardware.

Other changes in technology have also profoundly affected how people use computers. For example, the widespread proliferation of computers prompted the development of computer networks that allow computers to communicate with each other. With the introduction of the personal computer (PC), computing became accessible to large numbers of people. Networks for personal computers were developed to allow individual users to communicate with each other. In this manner, a large number of people within a company could communicate at the same time with a central software application running on one computer system. As a result of sharing a software application with numerous users, policies must be defined and enforced that control the access and use of particular applications on a server system.

Referring now to Prior Art FIG. 1, a block diagram 10 of a generic server system is shown. The generic server system comprises a user 20 connected to a server 21 by a data connection 24. Typically, user 20 will access an application 22 that is stored on server 21 over the Internet. In a corporate environment, the user 20 could be connected to the server by an internal network e.g., an Intranet. In addition, server 21 stores a set of user policies in a database 23 for authenticating access to software application 22. Typically, the user policy database 23 comprises user names and associated passwords. When a user provides credentials to access secure applications, the credentials are checked against the stored values.

Users on an Intranet have access to applications that would not typically be accessible to users that are not connected to the corporate network. By limiting the use of applications to users connected to the network, marginal security can be provided because only users inside the corporation can access the applications. Although somewhat secure, users may the configuration inconvenient because many users need to access applications on a corporate server when they are not at the office, e.g., on a business trip or working from home.

To overcome the problem of not being able to access applications when not connected to the Intranet, some networks are configured to allow remote access to a server over the Internet. To achieve secure remote access to a server, corporations create a “portal” for users to login to the server while not connected to the Intranet. Typically, a user will provide credentials such as a user name and password to gain access to the corporate server over the Internet. Once a user has provided accurate credentials, the server system checks a user policy database to verify if the user should have access to the particular application. Often, it is important for the user policies to be customized for different users because many times users do not need access to all applications stored on the server. In addition, there may be security reasons that prohibit everyone from accessing sensitive data such as payroll information.

For example, user policies defined for a human resources server prevent other personnel from viewing confidential salary information and other sensitive data. Furthermore, user policies for an engineering server allow authorized personnel from many internal segments of a company to publish and share research and development information. At the same time, the user policies restrict external partners from gaining access to proprietary information.

It is beneficial to create specific user policies for all users because it provides a fully customizable and more secure computing environment; but when a company becomes larger with more users and more applications, the user policy database can become very large and complex. For instance, if there are hundreds of employees accessing hundreds of applications, the size of the user policy database can grow exponentially. In addition, it becomes very difficult to update changes made to the policy database.

Although the specific user policies are beneficial for controlling access to sensitive applications, creating and managing such user policies can be a hindrance to the performance of a server system because the server must access a very large user policy database each time an application is accessed.

Furthermore, these policies that are defined by existing web servers cannot be centrally configured or administered for cluster implementations. Finally the scalability of these web servers suffer drastically as the number of policies increase.

Even if any such web server is built in the future that can realize these complex user policies, the customer may not have a choice of using better performing web servers because specific brands of servers only offer solutions for their servers. Thus, the customer using particular web servers would get locked to vendor specific features because the policy agents available are specific to the brand and type of server being used.

For example, organizations providing extranet access or web content have a range of different web servers, such as Sun™ One Web Server, IIS, Apache, Domino or custom application servers. Most access control solutions rely on agents or plug-ins that install directly on the web server software. These plug-ins are inherently limited to specific web server software or version. If one updates the version of the web server, new agents might not be available. In addition some web servers or custom platforms are not supported at all.

### SUMMARY OF THE INVENTION

Accordingly, what is needed is a policy agent that can plug into any web server, independent of the platform, to enforce user policies that are stored on a centralized server. The policy agent acts as a plug-in to any web server without touching the core functionality of the software. In addition, the policy agent should be scalable and centrally configured. In one aspect, the policy agent should store user policies, evaluate the policies and return policy values to control user access to resources on web servers independent of the platform they are running on. Embodiments of the present invention provide such a solution.

A system and method for enforcing user policies on web servers are presented. Embodiments of the present invention include a policy agent that enforces user policies on web servers that is generic to any web server platform. In one embodiment, the policy agent comprises a core policy library that stores the policy definitions and returns the policy values and an interface layer that interfaces the policy library with the web server and enforces the policies for specific users and applications. In one embodiment of the present invention, one core policy library can be shared by a plurality of policy agents running on different web servers. In this configuration, the policy agents and web servers can be in different locations while the core policy library is in a centralized location. Furthermore, the policy library can be protected by a firewall for added security.

Embodiments of the present invention can plug into any web server independent of the operating platform to enforce policies that are stored in a centralized server. The policy framework can be segmented into two parts that are loosely coupled to each other, thus facilitating the framework of the present invention to act as a plug-in for a web server without touching the core functionality of the software. The first part of the policy agent is the “agent interface layer” which comprises software code that is specific to the web server. The software code is generally minimal even though the web servers have a lot of different application interfaces to implement the HTTP protocol. For example, Sun™ One web servers use NSAPI application programming interface and IIS web servers use ISAPI application programming interface. However, they both adhere to HTTP 1.0/1.1 protocol specifications so the basic mechanism in the “agent interface layer” to intercept the HTTP event and enforce policy for the resource is the same.

The second part of the policy engine is the “core policy library” which is the policy library for the framework of the present invention. Most of the core functionality in the library is shared across all web servers. The purpose of the “core library” is to authenticate users and check for policies for a particular resource that the user is trying to access. The core library also helps maintain the agent cache for user policies, thus reducing the time it takes to retrieve user policies. In one embodiment of the present invention, once a policy for a user is stored in this cache memory from the server, the policy agent does not need to fetch the data from the server again. This greatly increases the performance of the web server by reducing the time to access user policy data.

In one embodiment of the present invention, the policy agent establishes a session between a client and a server, intercepts a HTTP request sent from the client to the server, constructs the URL for the information being requested, checks the HTTP header information for a cookie, checks a user policy database for user policies related to the client sending the request, and determines if the client should have access to the requested information. Additionally, in another embodiment of the present invention, the user policies are stored in a cache memory so the policy agent will be able to make a policy decision without referencing the user policy database.

The “plug and play” nature of the present invention allows users to configure multiple instances of the same web server with an already installed version of the agent. Instead of reinstalling multiple copies of the shared library or dynamically linked library, the same core policy library is shared across various web servers. The framework simply makes one copy of the configuration file for each agent confirmed for each instance of the same web server from a template configuration file stored with the shared policy library. This architecture also helps the framework to un-configure multiple instances of the agent for the same web server.

These and other objects and advantages of the present invention will no doubt become obvious to those of ordinary skill in the art after having read the following detailed description of the preferred embodiments, which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a block diagram of a prior art server system including an application stored on a server available to a user over a network connection.

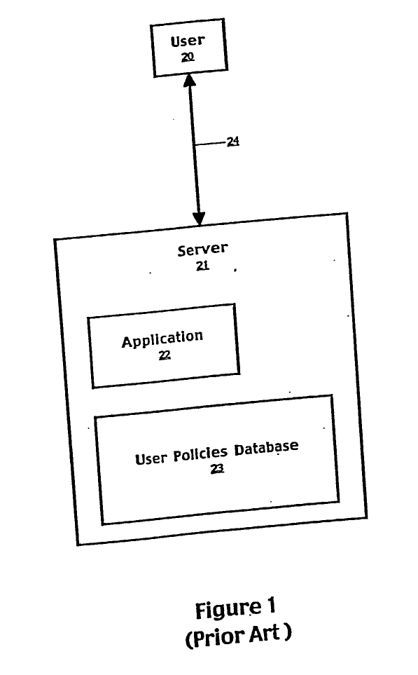

FIG. 2 is a logical block diagram of an exemplary computer system in accordance with an embodiment of the present invention.

FIG. 3 is a logical block diagram of a user policy agent comprising two core components in accordance with an embodiment of the present invention.

FIG. 4A is an illustration of a server system that uses a policy agent to intercept HTTP requests and enforce user access to information on a server in accordance with an embodiment of the present invention.

FIG. 4B is an illustration showing the interactions between server systems and a user in accordance with an embodiment of the present invention.

FIG. 5 is a flow diagram illustrating an exemplary process of intercepting an HTTP request and enforcing user policies on a server system in accordance with an embodiment of the present invention.

FIG. 6 is a flow diagram illustrating an exemplary process of installing a policy agent on any server in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail as not to unnecessarily obscure aspects of the present invention.

### Notation and Nomenclature

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. A procedure, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, bytes, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “setting,” “storing,” “scanning,” “receiving,” “sending,” “disregarding,” “entering,” or the like, refer to the action and processes (e.g., processes 500 and 600) of a computer system or similar intelligent electronic computing device, that manipulates and transforms data represented as physical (electronic) quantities within the computer system's registers and memories into other data similarly represented as physical quantities within the computer system memories or registers or other such information storage, transmission or display devices.

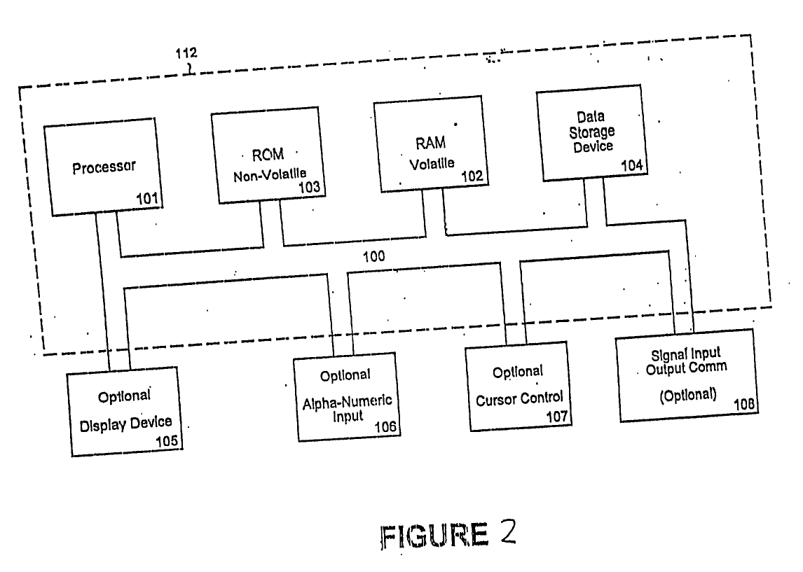

Referring now to FIG. 2, a block diagram of exemplary computer system 112 is shown. It is appreciated that computer system 112 of FIG. 2 described herein illustrates an exemplary configuration of an operational platform upon which embodiments of the present invention can be implemented. Nevertheless, other computer systems with differing configurations can also be used in place of computer system 112 within the scope of the present invention. For example, computer system 112 could be a server system, a personal computer or an embedded computer system such as a mobile telephone or pager system.

Computer system 112 includes an address/data bus 100 for communicating information, a central processor 101 coupled with bus 100 for processing information and instructions, a volatile memory unit 102 (e.g., random access memory, static RAM, dynamic RAM, etc.) coupled with bus 100 for storing information and instructions for central processor 101 and a non-volatile memory unit 103 (e.g., read only memory, programmable ROM, flash memory, EPROM, EEPROM, etc.) coupled with bus 100 for storing static information and instructions for processor 101. Computer system 112 may also contain an optional display device 105 coupled to bus 100 for displaying information to the computer user. Moreover, computer system 112 also includes a data storage device 104 (e.g., disk drive) for storing information and instructions. In one embodiment of the present invention, data storage device 104 is a cache memory.

Also included in computer system 112 of FIG. 2 is an optional alphanumeric input device 106. Device 106 can communicate information and command selections to central processor 101. Computer system 112 also includes an optional cursor control or directing device 107 coupled to bus 100 for communicating user input information and command selections to central processor 101. Computer system 112 also includes signal communication interface 108, which is also coupled to bus 100, and can be a serial port. Communication interface 108 can also include number of wireless communication mechanisms such as infrared or a Bluetooth protocol.

Although the generic policy engine system of the present invention may be implemented in a variety of different electronic systems such as a mobile computer system, an embedded system, etc., one exemplary embodiment includes the implementation on a computer server system. It should be understood that the descriptions corresponding to FIG. 2 provide some general information about an exemplary computing system.

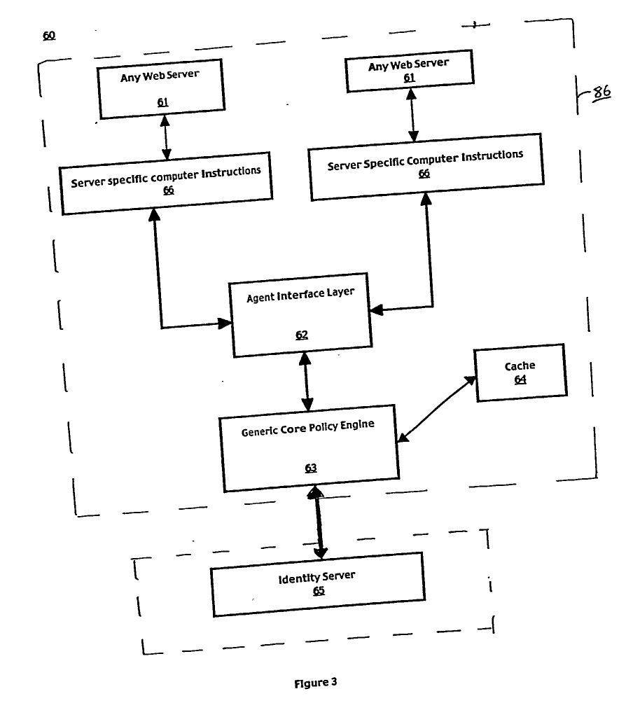

FIG. 3 is a logical block diagram 60 of a server system with a policy agent system 70. The server system 70 comprises an identity server 65 which is typically protected by a firewall and a web server system 86 which comprises a web server and a policy agent. The two components of the policy agent are the agent interface layer 62 and the generic core policy engine 63. In one embodiment of the present invention, the server 61 is a web server such as Sun™ One web server, Apache, or Microsoft IIS, but the server 61 could be any server running on any platform. In one embodiment of the present invention, the server specific code 66, the agent interface layer 62, and generic core policy engine 63 are installed on a web server while the Sun™ One identity server is on a remote server in a secure location, e.g., behind a firewall, thus ensuring security for user identity and policy enforcement. In addition more than one agent interface can use the same policy engine and data store, thus reducing the possibilities of inconsistencies in the policy data. In accordance with embodiments of the present invention, the generic policy engine 63 is not specific to any application but is rather generic and responds to high level requests for information. On the other hand, the interface 62 may be application specific. As described further below, the generic core policy engine performs evaluations which are done independent of the application program. The engine fetches the policy information from the identity server 65 which stores user policies in a secure location.

The server specific code 66 is the part of the policy agent 70 that is specific to the web server unlike the core policy engine 63. The software instructions are generally minimal even though different web servers use different interfaces for implementing the HTTP protocol. For example, Sun™ One web servers use NSAPI application programming interface and IIS web servers use ISAPI application programming interface. However, they both adhere to HTTP 1.0/1.1 protocol specifications so the basic mechanism in the server specific code 63 to intercept the HTTP event and enforce policy for the resource is the same. The server specific code 63 intercepts a HTTP request for a resource on the web server 61 and passes the request to the agent interface 62.

The agent Interface 62 of FIG. 3 decides if the resource requires policy enforcement by communicating with the core policy engine 63. Once the policy is fetched, the id is cached with the agent 64. If the resource does not require policy enforcement, the user is directed to the resource. Conversely, if the resource does require policy enforcement, the agent interface 62 intercepts the request and checks for a cookie or token in the header portion of the HTTP request to see if the user has established a session by previously providing credentials such as a login and password. If there is a cookie present, the cookie is validated by the generic core policy engine 63 by accessing a policy definition stored in either a cache memory 64 or a data store 65. Once the policy definition is accessed, the agent interface 62 uses the policy values to enforce the user access policy. If there is not a cookie available, the user is directed to an authentication page where credentials are required to access the particular resource. Once the user provides allowable credentials, a cookie is set in the browser and the cookie will maintain the session between the user and the web server 61.

In one embodiment of the present invention, policy definitions retrieved from the core policy engine 63 are stored in a cache memory 64 so the policy decisions can be made without accessing the Sun™ One identity server 65, thus reducing the time required to authenticate access to a resource. Furthermore, in one embodiment of the present invention, the agent performs an IP address verification to prevent users from using another's cookie on another browser to gain access to secure resources. In another embodiment of the present invention, if a cookie is not present, the generic policy engine 63 accesses identity server 65 to retrieve the user policy definitions for a particular user and resource. In one embodiment of the present invention, the user policy comprises a subject field and an object field. The subject field can be a user name or a role assignment. The object field is a resource such as a uniform resource locator (URL). Once the data is accessed from the identity server 65, the information is stored in a cache memory 64 so decisions can be made without accessing the identity server 65, thus reducing the time required to make policy decisions.

The agent interface 62 retrieves the policy decision values from the core policy engine 63 and enforces access to a particular resource. In one embodiment of the present invention, the agent interface 62 enforces policies that are more complex than yes or no decisions e.g., access granted or denied. For example, the agent interface 62 enforces policies such as a memory quota for an electronic mail program. For example, a user may access an electronic mail program on a server and attempt to use more than the allotted memory quota. The agent interface would intercept the request for more memory and limit the use of memory to the amount defined in user policy definition.

The next part of the system is the generic core policy engine 63 that performs the policy evaluations and returns the policy values to the agent interface 62 for enforcement. Most of the core functionality in the engine may be shared across all web servers, thus making it generic to almost any server running on any platform. One purpose of the core policy engine 63 is to define the policy definitions for multiple users and multiple resources, evaluate the policies and return the policy values to the agent 62. The core policy engine also helps maintain a cache memory for user policies, thus reducing the time it takes to retrieve user policies. In one embodiment of the present invention, once a policy for a user is loaded in the cache 64, the policy engine 63 does not need to fetch the data from the data store 65. The use of cache memory greatly increases the performance of the web server by reducing the time required to retrieve the policy definition for a user and application.

In one embodiment of the present invention, the identity server 65 may be located on a different server than the agent interface 62. For example, identity server 65 could be on a remote server that is protected by a firewall in different location than the web server 61. This arrangement allows more flexibility and scalability because many times the identity server 65 is in a different location than the web server 61. In addition, more than one policy agent can share the same identity server 65, thus reducing data inconsistencies. Furthermore, having the identity server 65 in a central location allows changes to be made by simply changing one database instead of multiple data stores.

In one embodiment, the core policy engine 63 which fetches and stores policies locally, defines policies and evaluates regarding policy inputs. The inputs generally define what a user is trying to access, e.g., the identification of the user, the objects trying to be accessed, e.g., resources, pages, etc, and mapping between the user and the resources is defined by the engine 63. The engine 63 also allows the granularity between policy definitions to be specified.

In a base form, the results of the evaluations may be a denial, allowance, or a max value check for authorized resources (e.g., an e-mail in-box quota, etc.). The generic policy engine may also provide data coherency functions, e.g., allowing detection of real time changes to the policies thereby keeping the agent cache 64 correct. The results of the evaluations are presented as an output from the generic policy engine 63. Decisions are made by the engine 63 and then enforced by the agent 62.

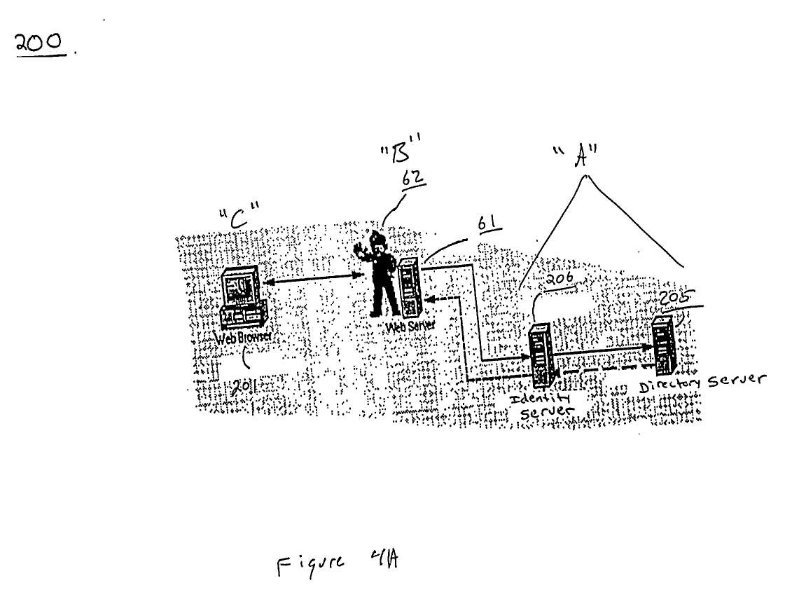

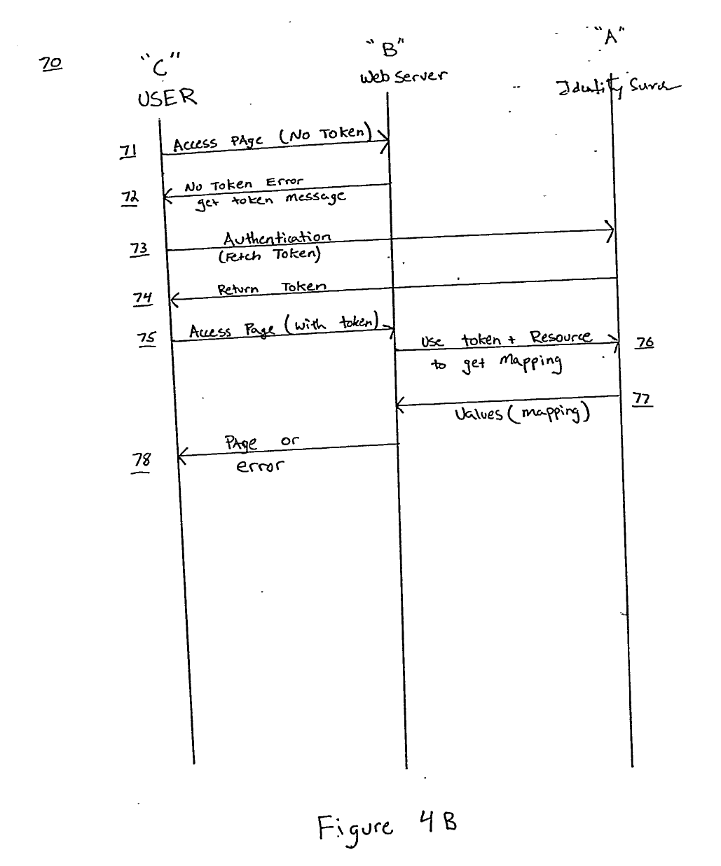

FIG. 4A is an illustration of a server system 200 showing a communication architecture between the policy agent and a web server 61. System 200 comprises a web browser 201 (C), web server 61 (B), policy agent 62(B), Sun™ One identity server 206 (A) and a Sun™ One directory server 205 (A). When a user wants to access a resource on the Internet, a web browser 201 is used to communicate with a web server 61. When a user tries to access a resource, e.g., a web page, the web browser 210 makes an HTTP request to the web server 61 to be directed to the resource. With the policy agent installed, the agent interface 62 intercepts the incoming HTTP request and checks if the user is authorized to access the resource. In the server system 200, the agent interface 62 and the core policy engine are 63 are on the web server 61. As described above, the core policy engine 63 accesses Sun™ One identity server 206 to retrieve policy definitions for different users and applications. In system 200 of FIG. 4, the data store that the identity server 206 accesses is on a separate directory server 205. In one embodiment of the present invention, the identity server 63 is coupled to a cache memory 64 as described in FIG. 3 so it does not have to retrieve the policy information from the identity server, thus decreasing the time to return the policy values to the agent interface 62.

In one embodiment of the present invention, a RADIUS or Certificate module is used to authenticate the user's credentials. In this case, the credentials are not verified by the directory server 205, but are verified by the appropriate authentication module (e.g., a RADIUS module). Once the user's credentials are properly authenticated, the URL policy agent examines the user policy definition and based on the policy definition assigned to the user, the user is either directed to the resource or denied access to the resource.

FIG. 4B is an illustration 70 showing the interaction between server systems and a user in accordance with an embodiment of the present invention. The designations A, B, and C correspond to the A, B,and C from FIG. 4A. In one embodiment, a user tries to access a web resource without a token 71. In this case, the user receives a “no token” error message. The user is then directed to an authentication resource where credentials can be provided 73. Once proper credentials are provided, a token is returned from the identity server (A) 74. In another embodiment, a user attempts to access a web resource with a token 75. When the web server receives the request, it uses the token and the resource being requested to get the mapping from the identity server 76. The identity server returns a value (mapping) back to the web server 77. Then the web server directs the user to the page, or gives an error message if the resource is not accessible.

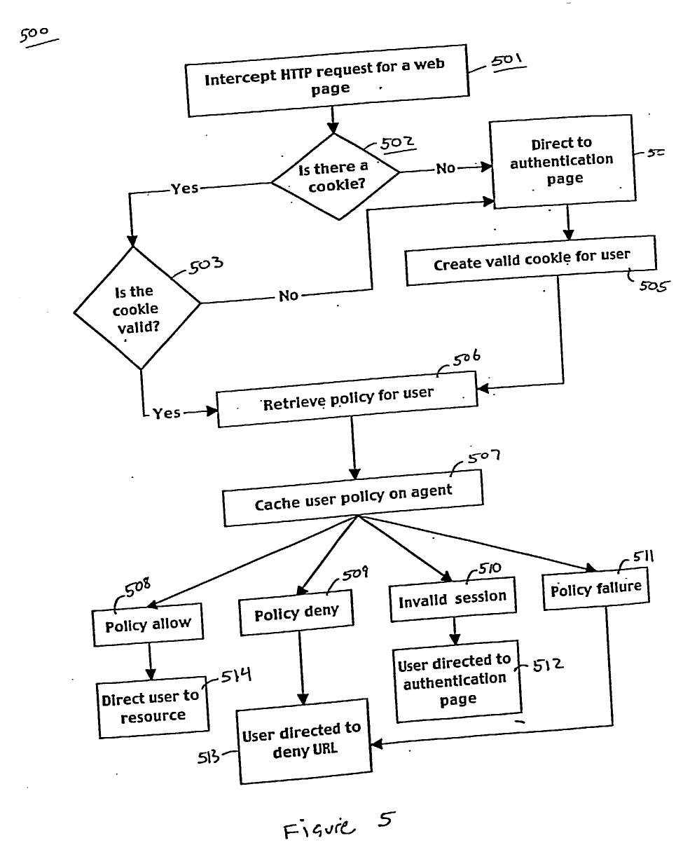

FIG. 5 is a computer implemented flow diagram 500 illustrating the process of intercepting an HTTP request and enforcing user policies on a server system in accordance with an embodiment of the present invention. The sequence of events starts by intercepting an HTTP request for a resource on a web server 501. Once loaded on a web server, the agent package 70 from FIG. 3 can be configured to receive a number of special filter event notifications that occur with each HTTP request that the web server receives and each response that the web server generates in return. The policy agent 70 from FIG. 3 is configured to filter predetermined HTTP events and enforce user policies for those events. For all other HTTP requests, the policy agent is transparent. The next step 502 is to determine if there is a cookie or token present in the HTTP request. As mentioned above, a cookie is stored in the web browser of the user after proper credentials have been provided, e.g., a user name and password. If there is a cookie present, the next step 503 is to check if the cookie is valid. The token or cookie information is sent by the agent interface 62 from FIG. 3 to the identity server from FIG. 3 to retrieve the user policy definition associated with the cookie in the next step 506. Once the agent 62 receives the policy definition, the agent stores the policy in a cache memory 507. Once the policy definition is stored in memory, the agent can enforce the policy.

One outcome of the policy enforcement is to allow access to the resource 508. If the credentials are verified and the user is allowed access to a particular resource, the agent directs the user to the correct resource 514. Another possible enforcement outcome is to deny access to a particular resource 509. In this case, the user is denied access to the URL 513. In one embodiment of the present invention, the agent directs the user to an error page describing the reason for being denied access to the requested resource.

Furthermore, an additional outcome of the policy enforcement is an invalid session 510. If a user is idle for too long, the cookie will expire and the session will terminate. In this case, the user is directed to the authentication page 512 where proper credentials can be provided to obtain a valid cookie. Lastly, in step 511, if the policy agent can't make an enforcement decision, a policy failure will occur. In this case, the user will be denied access to the resource 513.

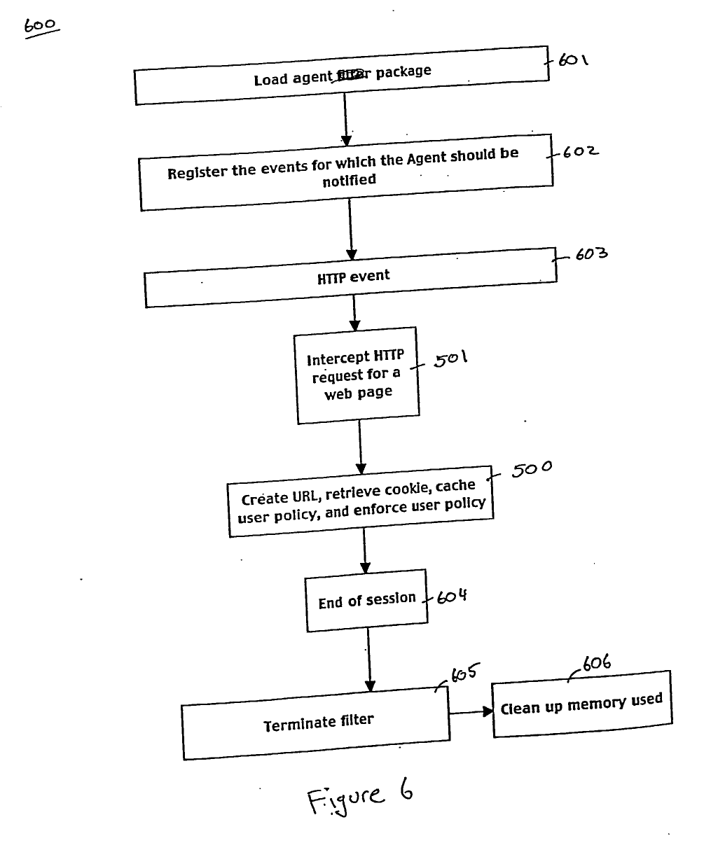

FIG. 6 is a computer implemented flow diagram illustrating the process of installing a policy engine on any server in accordance with an embodiment of the present invention. The agent package 70 from FIG. 3 is designed to be a “plug and play” package and the process for configuring the enforcement policies is very similar for all web servers. The first step 601 is to install the agent package. The next step 602 is to register the HTTP events for which the agent should be notified. When registering the HTTP events in the agent, it is possible to make the policies very complex or very simple depending on the desired level of protection. In one embodiment of the present invention, there can be individual policies for all users that define policies for all accessible resources. In another embodiment of the present invention, users can be assigned to roles, and each role has policy definitions. For example, a user in human resources would inherit all of the policy definitions as the rest of the users associated with the human resources role. By creating roles, a system administrator can change the user policies for many users at the same time by changing the policy definition for a single role.

Once the HTTP events are registered, the policy agent functions as described above. It intercepts a registered HTTP 603 and then follows the steps as described in process 500 of FIG. 5. Once a session is ended 604, the filter is terminated 605 and the cache memory is cleaned 606. The user can terminate a session, or it can be ended when a cookie expires.

The agent package provides a plug and play solution to policy enforcement on web servers because it can plug into almost any web server regardless of the vendor or platform it runs on. The policy agent can enforce complex policies for various resources that are stored within an organization. The agent pack segregates the policy framework from the web server thus making the architecture very scalable and flexible. Since the agent is a very thin layer on the web server, the agent activity minimally effects the performance of the server. In addition, the agent provides high performance even during heavy loads because it utilizes a cache memory to store the user policies while a session is maintained.

Embodiments of the present invention, a system and method for enforcing user policies on a web server have been described. While the present invention has been described in particular embodiments, it should be appreciated that the present invention should not be construed as limited by such embodiments, but rather construed according to the following Claims.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and it's practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1.) A method for accessing information comprising:
a) using a generic policy agent to intercept a request made by a client for a resource accessible from a server;
b) accessing a token in the header portion of said request;
c) accessing a user policy associated with said token from a database;
d) evaluating if said client is allowed access to said requested resource based on said user policy; and
e) if said client is allowed access to said requested information, directing said user to said requested resource, wherein said d) and e) are performed by said generic policy agent.

2.) A method as described in claim 1 further comprising storing said user policy in a cache memory.

3.) A method as described in claim 1 wherein said request is an HTTP request.

4.) A method as described in claim 1 wherein step a) further comprises validating an IP address of said client.

5.) A method as described in claim 1 wherein said user policy comprises a subject field and an object field.

6.) A method as described in claim 5 wherein said subject field is a role assignment associated with said client.

7.) A method as described in claim 1 further comprising directing said client to an authentication application.

8.) A method as described in claim 1 wherein said database is stored on a remote identity server.

9.) A method as described in claim 1 wherein said generic policy agent comprises:
a generic policy library storing user policies for a plurality of clients;
a generic policy engine that returns said user policies;
a generic interface layer enforcing said user policies based on said policy values; and
server specific software instructions for interfacing said generic policy agent with a specific server.

10.) A method as described in claim 9 wherein said server system is a web server.

11.) A computer implemented system for regulating access to information comprising:
a) a generic agent interface coupled to a server for intercepting an incoming HTTP request associated with a user and for enforcing user policies for a predetermined resource;
b) a generic policy library for fetching and storing said user policies for a plurality of users and HTTP resources; and
c) a generic policy engine that accesses said policy library and uses said user policies to determine a policy value, wherein said policy value is sent to said generic agent interface wherein said policy is enforced and wherein further said generic policy engine is not application specific.

12.) A system as described in claim 11 wherein said agent interface comprises a server specific set of computer instructions for interfacing said policy agent with a specific server.

13.) A system as described in claim 11 further comprising a cache memory for storing said user policies.

14.) A system as described in claim 11 wherein said agent interface is application specific and verifies an IP address of said incoming HTTP request.

15.) A system as described in claim 11 wherein said generic policy library communicates with an identity server to retrieve said user policies.

16.) A system as described in claim 15 wherein said remote identity server is protected by a firewall.

17.) A system as described in claim 11 wherein said server is a web server.

18.) A system as described in claim 11 wherein a plurality of agent interfaces access a centralized policy library.

19.) A system as described in claim 11 wherein said policy value indicates access allowance or access denied.

20.) In a server system comprising a processor coupled to a bus and a memory coupled to said bus, a computer readable medium comprising instructions that when executed implement a method of accessing information said method comprising:
a) using a generic policy agent to intercept an HTTP request made by a client for a resource accessible from said server system;
b) accessing a token in a header portion of said HTTP request to determine if a cookie is present and if no cookie is present, directing said client to an authentication application;
c) provided said cookie is present, accessing a user policy associated with said token from a database;
d) using a generic policy agent to determine if said client is allowed access to said requested resource based on said user policy wherein said generic policy agent comprises an application inspecific policy engine; and
e) if said client is allowed access to said requested resource, using an application specific policy agent to direct said user to said requested resource.

21.) A computer readable medium as described in claim 20 further comprising instructions for storing said user policy in a cache memory.

22.) A computer readable medium as described in claim 20 further comprising instructions for verifying an IP address of said client.

23.) A computer readable medium as described in claim 20 wherein said user policy comprises a subject entry and an object entry and wherein said subject entry is a user classification and said object entry is a resource.

24.) A computer readable medium as described in claim 23 wherein said user classification is a role assignment.

25.) A computer readable medium as described in claim 20 wherein said database for storing policies is a directory server.

26.) A communication system comprising:
an application specific agent interface module for enforcing a policy regarding a user access request for resources and wherein said agent interface module comprises server-specific instructions;
a generic policy engine for evaluating said user access request and for determining said policy based thereon and wherein said generic policy engine is application inspecific and wherein further said user access request identifies said user and said resources and wherein said policy indicates allowance or rejection of said request; and
an identity server coupled to communicate with said policy engine and for containing mapping information.

27.) A communication system as described in claim 26 wherein said agent interface is resident on a first server computer system.

28.) A communication system as described in claim 27 wherein said generic policy engine is resident on a second server computer system in communication with said first server computer system.

29.) A communication system as described in claim 28 wherein said user access request originates from a third computer system in communication with said first server computer system.

30.) A communication system as described in claim 28 wherein said identity server is resident on a fourth server computer system.

31.) A communication system as described in claim 30 wherein said first server computer system is a web server, said third computer system is a web browser and said fourth server computer system is an identity server.
